(19) United States
(12) Patent Application Publication
(10) Pub. No.: US 2026/0065670 A1
(43) Pub. Date: Mar. 5, 2026

(54) GENERATING VIDEO DESCRIPTIONS USING A MACHINE LEARNING MODEL

(71) Applicant: Lemon Inc., Grand Cayman (KY)

(72) Inventors: Lu Xu, Los Angeles, CA (US); Sijie Zhu, Los Angeles, CA (US); Fan Chen, Los Angeles, CA (US); Longyin Wen, Los Angeles, CA (US)

(21) Appl. No.: 18/823,603

(22) Filed: Sep. 3, 2024

(51) Int. Cl. G06V 20/40; G06F 40/284; G06V 20/70

(52) U.S. Cl. CPC G06V 20/41; G06F 40/284; G06V 20/70

(57) ABSTRACT

The present disclosure describes techniques for generating video descriptions using a machine learning model. A plurality of sets of visual tokens corresponding to a plurality of frames of a video is generated. A first type of tokens is generated by implementing temporal pooling on the plurality of sets of visual tokens corresponding to the plurality of frames. A second type of tokens is generated by compressing each of the plurality of sets of visual tokens corresponding to each of the plurality of frames. A third type of tokens is generated by applying cross-attention between each of the plurality of sets of visual tokens and a fourth type of tokens including text tokens generated based on an input text query. A text description of the video is generated based on the first type of tokens, the second type of tokens, the third type of tokens, and the fourth type of tokens.

### BACKGROUND

Machine learning models are increasingly being used across a variety of industries to perform a variety of different tasks. Such tasks may include generating video descriptions. Improved techniques for utilizing machine learning models for video description generation are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for generating video descriptions using a machine learning model in accordance with the present disclosure.

FIG. 2 shows an example system for generating different types of tokens in accordance with the present disclosure.

FIG. 3 shows an example system for generating video descriptions using a machine learning model in accordance with the present disclosure.

FIG. 4 shows an example system for training a machine learning model in accordance with the present disclosure.

FIG. 5 shows an example process for generating video descriptions using a machine learning model in accordance with the present disclosure.

FIG. 6 shows an example process for generating video descriptions using a machine learning model in accordance with the present disclosure.

FIG. 7 shows an example process for generating video descriptions using a machine learning model in accordance with the present disclosure.

FIG. 8 shows an example process for generating video descriptions using a machine learning model in accordance with the present disclosure.

FIG. 9 shows an example table illustrating performance data in accordance with the present disclosure.

FIG. 10 shows an example computing device which may be used to perform any of the techniques disclosed herein.

### DETAILED DESCRIPTION OF ILLUSTRATIVE EMBODIMENTS

Large vision language models (e.g., multi-modal large language models) can be used for zero-shot image understanding. While it is desirable to also use large vision language models for video understanding, existing large vision language models do not perform as well on video understanding tasks as image understanding tasks. As such, techniques for improving large vision language models are needed.

Described herein are improved techniques for improving large vision language models. Described herein is a machine learning model having a three-branch architecture. Visual tokens representative of each frame of a video can be fed into each of the three branches. The first branch is configured to utilize the visual tokens to generate tokens that are temporally pooled from all frames of the video. The second branch is configured to utilize the visual tokens to generate spatially pooled tokens from each frame of the video. The third branch applies cross-attention between text query tokens and the visual tokens from each frame of the video to get visual-text tokens for each frame of the video. These three different types of tokens are fed into a multilayer perceptron (MLP). The MLP can project the three different types of tokens into an input space of a sub-model (e.g., large language model) of the machine learning model. The sub-model can generate, based on the three different types of tokens and the text query tokens, a text description of the video. To enable the machine learning model to distinguish between the three different types of tokens and the text query tokens, text indicator tokens can be added in between each of the three different types of tokens and the text query tokens before the tokens are fed into the sub-model. The text indicator tokens can be generated using real text that is understandable by the sub-model.

This three-branch framework can extract and fuse information from different perspectives, significantly reducing the number of tokens that need to be fed into the sub-model while retaining original video information to a maximum extent. When the sub-model is implemented as a large language model, parameters of the sub-model can be updated during the end-to-end training of the whole pipeline, which may improve the performance of the pipeline on video understanding tasks.

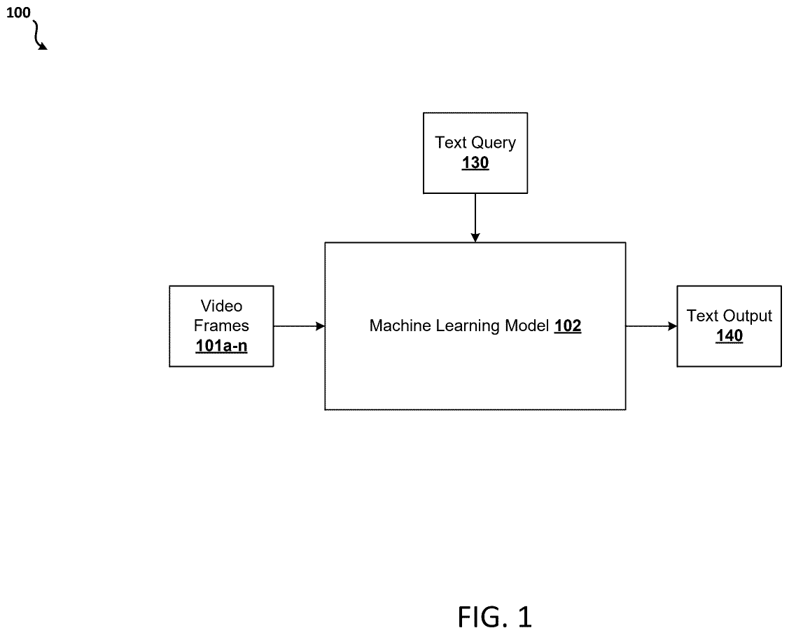

FIG. 1 illustrates an example system 100 in accordance with the present disclosure. The system 100 can include a machine learning model 102. The machine learning model 102 can receive, as input, a plurality of input video frames 101a-n and a text query 130. The text query 130 can include a query indicating a question to be answered about the plurality of input video frames 101a-n and/or any other natural language task to be performed with respect to the plurality of input video frames 101a-n.

The machine learning model 102 can generate visual tokens based on the plurality of input video frames 101a-n. The machine learning model 102 can generate a set of visual tokens representative of each frame among the plurality of input video frames 101a-n. For example, the machine learning model 102 can generate a first set of visual tokens representative of the input video frame 101a, a second set of visual tokens representative of the input video frame 101b, a third set of visual tokens representative of the input video frame 101c, and so on. The machine learning model 102 can include an encoder (e.g., a Contrastive Language-Image Pre-Training (CLIP) encoder). The encoder can be configured to generate the visual tokens based on the plurality of input video frames 101a-n. The machine learning model 102 can generate a text tokens based on the text query 130. For example, the machine learning model 102 can generate a set of text tokens representative of the text query 130. The machine learning model 102 can generate the text tokens using any suitable technique, such as by using one or more text encoders.

The machine learning model 102 can generate text output 140. The machine learning model 102 can generate the text output 140 based on the visual tokens and the text tokens. For example, visual tokens can be projected into an input space of the machine learning model 102 to align the visual tokens with the text tokens. The machine learning model 102 can generate the text output 140 based on the aligned visual tokens and text tokens. The text output 140 can include a text description of one or more of the plurality of input video frames 101a-n. The text description 140 of the one or more of the plurality of input video frames 101a-n can be responsive to the text query 130.

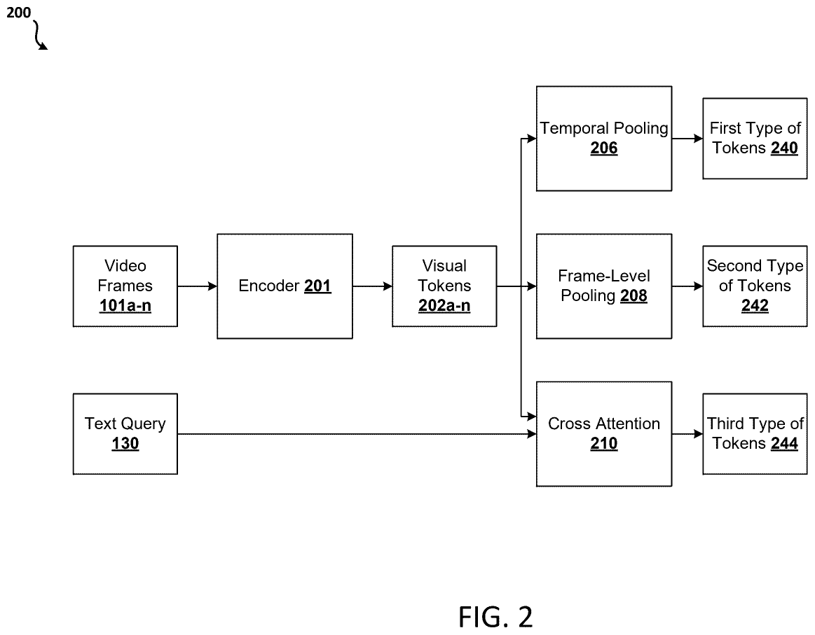

FIG. 2 illustrates an example system 200 showing a three-branch architecture of the machine learning model 102. The machine learning model 102 can include an encoder 202. The encoder 202 can include, for example, a CLIP encoder. The encoder 202 can be generate visual tokens 202a-n based on the plurality of input video frames 101a-n. The visual tokens 202a-n can include a set of visual tokens representative of each frame among the plurality of input video frames 101a-n. For example, the visual tokens 202a-n can include a first set of visual tokens representative of the input video frame 101a, a second set of visual tokens representative of the input video frame 101b, a third set of visual tokens representative of the input video frame 101c, and so on. The visual tokens 202a-n can be fed into each of three branches: a first branch for temporal pooling 206, a second branch for frame-level pooling 208, and a third branch for cross-attention 210. The visual tokens 202a-n can be fed into each of three branches simultaneously and/or in parallel.

The first branch for temporal pooling 206 can utilize the visual tokens 202a-n to generate and output a first type of tokens 240. The first branch for temporal pooling 206 can generate the first type of tokens 240by implementing temporal pooling on the visual tokens 202a-n corresponding to the plurality of input video frames 101a-n. Implementing the temporal pooling on the visual tokens 202a-n corresponding to the plurality of input video frames 101a-n can include averaging the visual tokens 202a-n across the plurality of input video frames 101a-n.

Averaging the visual tokens 202a-n across the plurality of input video frames 101a-n can include reducing the number of visual tokens in the temporal dimension while maintaining spatial information. For example, the visual tokens 202a-n can include three sets of tokens before temporal pooling: a first set of visual tokens representative of the input video frame 101a, a second set of visual tokens representative of the input video frame 101b, and a third set of visual tokens representative of the input video frame 101c, with each set of visual tokens including 100 tokens. After temporal pooling, only 100 tokens may remain (e.g., the first type of tokens 240 can include 100 tokens).

The second branch for frame-level pooling 208 can utilize the visual tokens 202a-n to generate and output a second type of tokens 242. The second branch for frame-level pooling 208 can generate the second type of tokens 242 by compressing the visual tokens 202a-n corresponding to each of the plurality of input video frames 101a-n. Compressing the visual tokens 202a-n corresponding to each of the plurality of input video frames 101a-n can include averaging each of the plurality of sets of visual tokens corresponding to each of the plurality of input video frames 101a-n.

Averaging each of the plurality of sets of visual tokens corresponding to each of the plurality of input video frames 101a-n can include reducing the number of visual tokens in the spatial dimension while maintaining temporal information. For example, the visual tokens 202a-n can include three sets of tokens before frame-level pooling: a first set of visual tokens representative of the input video frame 101a, a second set of visual tokens representative of the input video frame 101b, and a third set of visual tokens representative of the input video frame 101c, with each set of visual tokens including 100 tokens. After frame-level pooling, the first set of visual tokens representative of the input video frame 101a can be averaged to generate a single visual token, the second set of visual tokens representative of the input video frame 101b can be averaged to generate a single visual token, and the third set of visual tokens representative of the input video frame 101c can be averaged to generate a single visual token. As such, after frame-level pooling, only three tokens may remain (e.g., the second type of tokens 242 can include three tokens).

As described above, the second branch for frame-level pooling 208 can reduce spatial information. However, it is undesirable to lose too much spatial information, especially spatial information that is pertinent to the text query 130. For example, the text query 130 can include a question related to the color of a bird shown in one or more of plurality of input video frames 101a-n. Spatial information indicative of the color of the bird may have been reduced or eliminated by the second branch for frame-level pooling 208. The third branch for cross-attention 210 can be used to ensure that spatial information that is pertinent to the text query 130 is not lost. The third branch for cross-attention 210 can utilize the visual tokens 202a-n to generate and output a third type of tokens 244. The third branch for cross-attention 210 can apply cross-attention between each of the plurality of sets of visual tokens and a fourth type of tokens. The fourth type of tokens can include text tokens generated based on the text query 130.

Applying cross-attention between each of the plurality of sets of visual tokens and the fourth type of tokens can include reducing the number of visual tokens in the spatial dimension, while maintaining both temporal information and spatial information that is pertinent to the text query 130. For example, the visual tokens 202a-n can include three sets of tokens before applying cross-attention: a first set of visual tokens representative of the input video frame 101a, a second set of visual tokens representative of the input video frame 101b, and a third set of visual tokens representative of the input video frame 101c, with each set of visual tokens including 100 tokens. After applying cross-attention, the first set of visual tokens representative of the input video frame 101a can be averaged to generate a single visual token that is pertinent to the text query 130, the second set of visual tokens representative of the input video frame 101b can be averaged to generate a single visual token that is pertinent to the text query 130, and the third set of visual tokens representative of the input video frame 101c can be averaged to generate a single visual token that is pertinent to the text query 130. As such, after applying cross-attention, only three tokens may remain (e.g., the third type of tokens 244 can include three tokens pertinent to the text query 130).

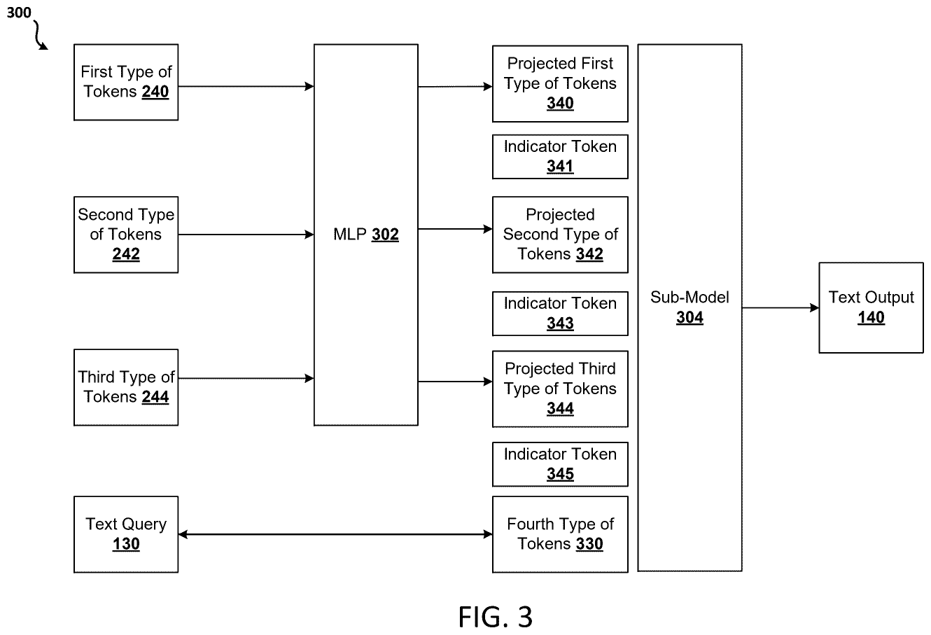

FIG. 3 illustrates an example system 300 showing the three-branch architecture of the machine learning model 102. The first type of tokens 240 generated by the first branch for temporal pooling 206 can be input into an MLP 302. The second type of tokens 242 generated by the second branch for frame-level pooling 208 can be input into the MLP 302. The third type of tokens 244 generated by the third branch for cross-attention 210 can be input into the MLP 302. The MLP 302 can project the first type of tokens 240, the second type of tokens 242, and the third type of tokens 244 into an input space of a sub-model 304 of the machine learning model 102 (e.g., a text space). The sub-model 304 can be a large language model. The MLP 302 can project the first type of tokens 240, the second type of tokens 242, and the third type of tokens 244 so as to align the first type of tokens 240, the second type of tokens 242, and the third type of tokens 244 with a fourth type of tokens 330.

The projected first type of tokens 340, the projected second type of tokens 342, the projected third type of the tokens 344, and the fourth type of tokens 330 can be separated from each other using indicator tokens (e.g., predetermined indicator tokens). The indicator tokens can enable the sub-model 304 to distinguish between the projected first type of tokens 340, the projected second type of tokens 342, the projected third type of the tokens 344, and the fourth type of tokens 330. For example, the projected first type of tokens 340 can be separated from the projected second type of tokens 342 using an indicator token 341. The projected second type of tokens 342 can be separated from the projected third type of the tokens 344 using an indicator token 343. The projected third type of the tokens 344 can be separated from the fourth type of tokens 330 using an indicator token 345. The indicator token 341, the indicator token 343, and the indicator token 345 can be predetermined and can be different from each other.

The projected first type of tokens 340, the projected second type of tokens 342, the projected third type of the tokens 344, the fourth type of tokens 330, and the indicator tokens can be concatenated. The concatenated tokens can be input into the sub-model 304. The sub-model 304 can generate the text output 140 based on the concatenated tokens. The sub-model 304 can include, for example, a large language model.

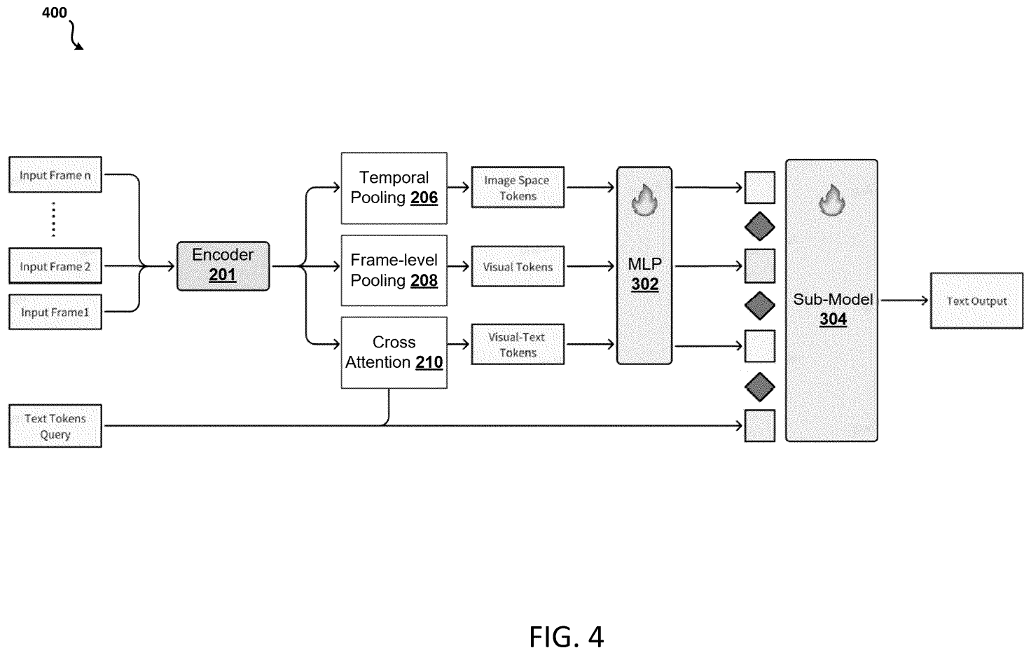

FIG. 4 shows an example system 400 for training the machine learning model 102 in accordance with the present disclosure. High-quality training data can be generated by collecting videos. At least a portion of the videos can be collected by rendering one or more other videos. The training data can include a plurality of video, question, answer (VQA) pairs. Each of the VQA pairs can belong to one of three categories: conversation, reasoning, and temporal. Adversary questions can also be generated to induce the machine learning model 102 to generate wrong answers and the machine learning model 102 can be corrected with good answers from the training data. The training data can be used to train the machine learning model 102. The encoder 201 can be pre-trained. As such, the parameters of the encoder 201 can be frozen during training of the machine learning model 102. The parameters of the MLP 302 and the parameters of the sub-model 304 can be trained (e.g., updated) using the training data. For example, the parameters of the MLP 302 and the parameters of the sub-model 304 can be trained using each VQA pair and/or the adversary questions.

Training the parameters of the MLP 302 and the parameters of the sub-model 304 on a particular VQA pair can include inputting frames of the corresponding video (e.g., the V) into the pre-trained encoder 201. The encoder 201 can generate visual tokens representative of the frames. The visual tokens can be fed into each of the first branch for temporal pooling 206, the second branch for frame-level pooling 208, and the third branch for cross-attention 210. Text-query tokens (e.g., the Q) from the VQA pair can also be input into the cross-attention 210.

The first branch for temporal pooling 206 can generate tokens (e.g., image space tokens) that are temporally pooled from all of the frames. The second branch for frame-level pooling 208 can generate tokens (e.g., visual tokens) from each frame of the video. The third branch for cross-attention 210 can apply cross-attention between text-query tokens and the visual tokens to get visual-text tokens for each frame of the video.

These three different types of tokens are fed into the MLP 302. The MLP 302 can learn to project the three different types of tokens into the input space of the sub-model 304 to align with the text-query tokens. To enable the sub-model 304 to learn to distinguish the three different types of tokens and the text query tokens from each other, text indicator tokens can be added between each of the three different types of tokens and the text query tokens before the tokens are fed into the sub-model 304 during each training iteration. The text indicator tokens can be generated using real text that is understandable by the sub-model 304. The sub-model 304 can generate a text output based on the projected three different types of tokens and the text-query tokens. The text output can be compared to a ground truth text output (e.g., the A) in the VQA pair to determine a loss. This process can be repeated to minimize the loss (e.g., until the loss satisfies a threshold).

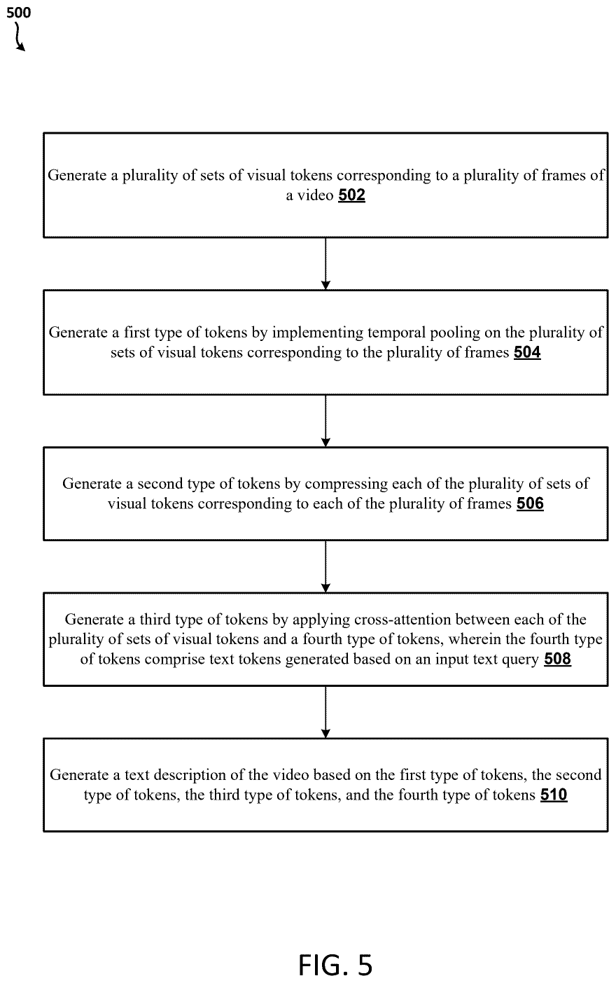

FIG. 5 shows an example process 500 for generating video descriptions using a machine learning model. Although depicted as a sequence of operations in FIG. 5, those of ordinary skill in the art will appreciate that various embodiments may add, remove, reorder, or modify the depicted operations.

At 502, a plurality of sets of visual tokens (e.g., visual tokens 202a-n) corresponding to a plurality of frames (e.g., plurality of frames 201a-n) of a video can be generated. For example, the plurality of sets of visual tokens can include a first set of visual tokens representative of a first frame of the video, a second set of visual tokens representative of a second frame of the video, a third set of visual tokens representative of the third frame of the video, and so on. The plurality of sets of visual tokens can be fed into each of three branches of a machine learning model: a first branch for temporal pooling (e.g., first branch for temporal pooling 206), a second branch for frame-level pooling (e.g., second branch for frame-level pooling 208), and a third branch for cross-attention (e.g., third branch for cross-attention 210). The plurality of sets of visual tokens can be fed into each of three branches simultaneously and/or in parallel.

At 504, a first type of tokens (e.g., first type of tokens 240) can be generated. The first type of tokens can be generated by the first branch of the machine learning model. The first type of tokens can be generated by implementing temporal pooling on the plurality of sets of visual tokens corresponding to the plurality of frames. The first type of tokens can reduce the number of visual tokens in the temporal dimension while maintaining spatial information.

At 506, a second type of tokens (e.g., second type of tokens 242) can be generated. The second type of tokens can be generated by the second branch of the machine learning model. The second type of tokens can be generated by compressing each of the plurality of sets of visual tokens corresponding to each of the plurality of frames. The second type of tokens can reduce the number of visual tokens in the spatial dimension while maintaining temporal information.

At 508, a third type of tokens (e.g., third type of tokens 244) can be generated. The third type of tokens can be generated by the third branch of the machine learning model. The third type of tokens can be generated by applying cross-attention between each of the plurality of sets of visual tokens and a fourth type of tokens (e.g., fourth type of tokens 330). The fourth type of tokens comprise text tokens generated based on an input text query (e.g., text query 130).

At 510, a text description (e.g., text output 140) can be generated. The text description can include a description of the video. For example, the text description can be responsive to input text query. The text description can be generated based on the first type of tokens, the second type of tokens, the third type of tokens, and the fourth type of tokens.

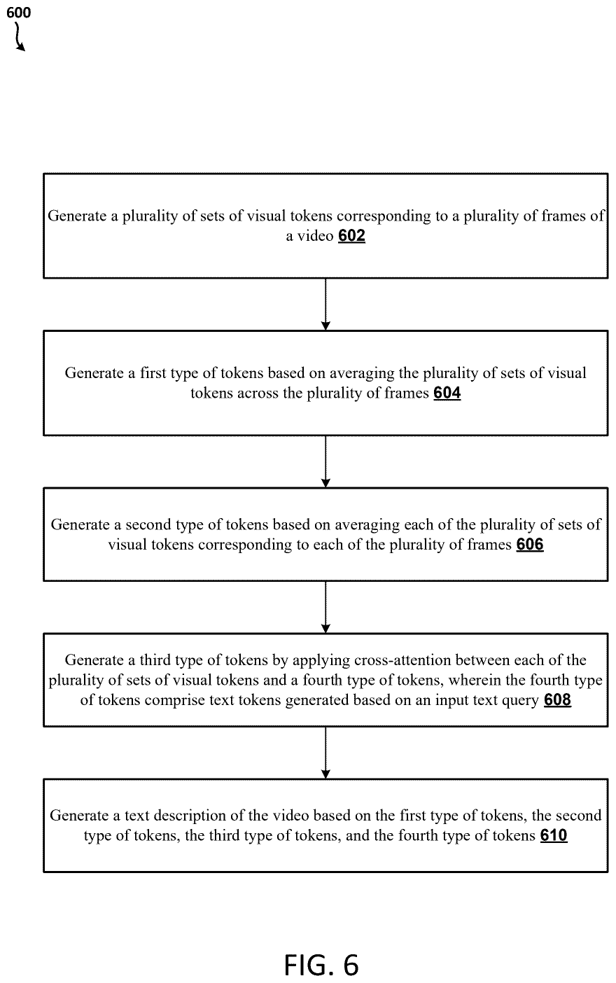

FIG. 6 shows an example process 600 for generating video descriptions using a machine learning model. Although depicted as a sequence of operations in FIG. 6, those of ordinary skill in the art will appreciate that various embodiments may add, remove, reorder, or modify the depicted operations.

At 602, a plurality of sets of visual tokens (e.g., visual tokens 202a-n) corresponding to a plurality of frames (e.g., plurality of frames 201a-n) of a video can be generated. For example, the plurality of sets of visual tokens can include a first set of visual tokens representative of a first frame of the video, a second set of visual tokens representative of a second frame of the video, a third set of visual tokens representative of the third frame of the video, and so on. The plurality of sets of visual tokens can be fed into each of three branches of a machine learning model: a first branch for temporal pooling (e.g., first branch for temporal pooling 206), a second branch for frame-level pooling (e.g., second branch for frame-level pooling 208), and a third branch for cross-attention (e.g., third branch for cross-attention 210). The plurality of sets of visual tokens can be fed into each of three branches simultaneously and/or in parallel.

At 604, a first type of tokens (e.g., first type of tokens 240) can be generated. The first type of tokens can be generated by the first branch of the machine learning model. The first type of tokens can be generated by implementing temporal pooling on the plurality of sets of visual tokens corresponding to the plurality of frames. Implementing the temporal pooling on the plurality of sets of visual tokens corresponding to the plurality of frames can include averaging the plurality of sets of visual tokens across the plurality of frames. Averaging the plurality of sets of visual tokens across the plurality of frames can include reducing the number of visual tokens in the temporal dimension while maintaining spatial information.

At 606, a second type of tokens (e.g., second type of tokens 242) can be generated. The second type of tokens can be generated by the second branch of the machine learning model. The second type of tokens can be generated by compressing each of the plurality of sets of visual tokens corresponding to each of the plurality of frames. Compressing each of the plurality of sets of visual tokens corresponding to each of the plurality of frames can include averaging each of the plurality of sets of visual tokens corresponding to each of the plurality of frames. Averaging each of the plurality of sets of visual tokens corresponding to each of the plurality of frames can include reducing the number of visual tokens in the spatial dimension while maintaining temporal information.

At 608, a third type of tokens (e.g., third type of tokens 244) can be generated. The third type of tokens can be generated by the third branch of the machine learning model. The third type of tokens can be generated by applying cross-attention between each of the plurality of sets of visual tokens and a fourth type of tokens (e.g., fourth type of tokens 330). The fourth type of tokens comprise text tokens generated based on an input text query (e.g., text query 130).

At 610, a text description (e.g., text output 140) can be generated. The text description can include a description of the video. For example, the text description can be responsive to input text query. The text description can be generated based on the first type of tokens, the second type of tokens, the third type of tokens, and the fourth type of tokens.

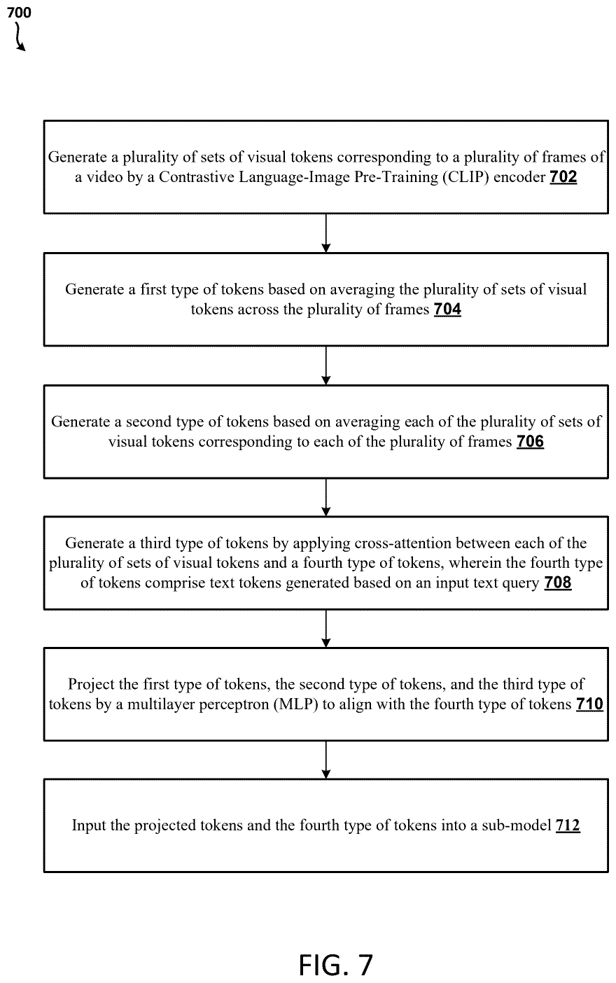

FIG. 7 shows an example process 700 for generating video descriptions using a machine learning model. Although depicted as a sequence of operations in FIG. 7, those of ordinary skill in the art will appreciate that various embodiments may add, remove, reorder, or modify the depicted operations.

At 702, a plurality of sets of visual tokens (e.g., visual tokens 202a-n) corresponding to a plurality of frames (e.g., plurality of frames 201a-n) of a video can be generated. The plurality of sets of visual tokens can be generated by a CLIP encoder. For example, the plurality of sets of visual tokens can include a first set of visual tokens representative of a first frame of the video, a second set of visual tokens representative of a second frame of the video, a third set of visual tokens representative of the third frame of the video, and so on. The plurality of sets of visual tokens can be fed into each of three branches of a machine learning model: a first branch for temporal pooling (e.g., first branch for temporal pooling 206), a second branch for frame-level pooling (e.g., second branch for frame-level pooling 208), and a third branch for cross-attention (e.g., third branch for cross-attention 210). The plurality of sets of visual tokens can be fed into each of three branches simultaneously and/or in parallel.

At 704, a first type of tokens (e.g., first type of tokens 240) can be generated. The first type of tokens can be generated by the first branch of the machine learning model. The first type of tokens can be generated by implementing temporal pooling on the plurality of sets of visual tokens corresponding to the plurality of frames. Implementing the temporal pooling on the plurality of sets of visual tokens corresponding to the plurality of frames can include averaging the plurality of sets of visual tokens across the plurality of frames. Averaging the plurality of sets of visual tokens across the plurality of frames can include reducing the number of visual tokens in the temporal dimension while maintaining spatial information.

At 706, a second type of tokens (e.g., second type of tokens 242) can be generated. The second type of tokens can be generated by the second branch of the machine learning model. The second type of tokens can be generated by compressing each of the plurality of sets of visual tokens corresponding to each of the plurality of frames. Compressing each of the plurality of sets of visual tokens corresponding to each of the plurality of frames can include averaging each of the plurality of sets of visual tokens corresponding to each of the plurality of frames. Averaging each of the plurality of sets of visual tokens corresponding to each of the plurality of frames can include reducing the number of visual tokens in the spatial dimension while maintaining temporal information.

At 708, a third type of tokens (e.g., third type of tokens 244) can be generated. The third type of tokens can be generated by the third branch of the machine learning model. The third type of tokens can be generated by applying cross-attention between each of the plurality of sets of visual tokens and a fourth type of tokens (e.g., fourth type of tokens 330). The fourth type of tokens comprise text tokens generated based on an input text query (e.g., text query 130).

The first type of tokens, the second type of tokens, and the third type of tokens can be input into an MLP (e.g., MLP 302). At 710, the first type of tokens can be projected by the MLP. The first type of tokens can be projected by the MLP to align with the fourth type of tokens. The second type of tokens can be projected by the MLP. The second type of tokens can be projected by the MLP to align with the fourth type of tokens. The third type of tokens can be projected by the MLP. The third type of tokens can be projected by the MLP to align with the fourth type of tokens. For example, the MLP can project the first type of tokens, the second type of tokens, and the third type of tokens into a lower-dimensional space to align with the fourth type of tokens.

At 712, the projected tokens and the fourth type of tokens can be input into a sub-model (e.g., sub-model 304). The sub-model can generate a text description (e.g., text output 140) based on the projected tokens and the fourth type of tokens. The text description can include a description of the video. For example, the text description can be responsive to input text query.

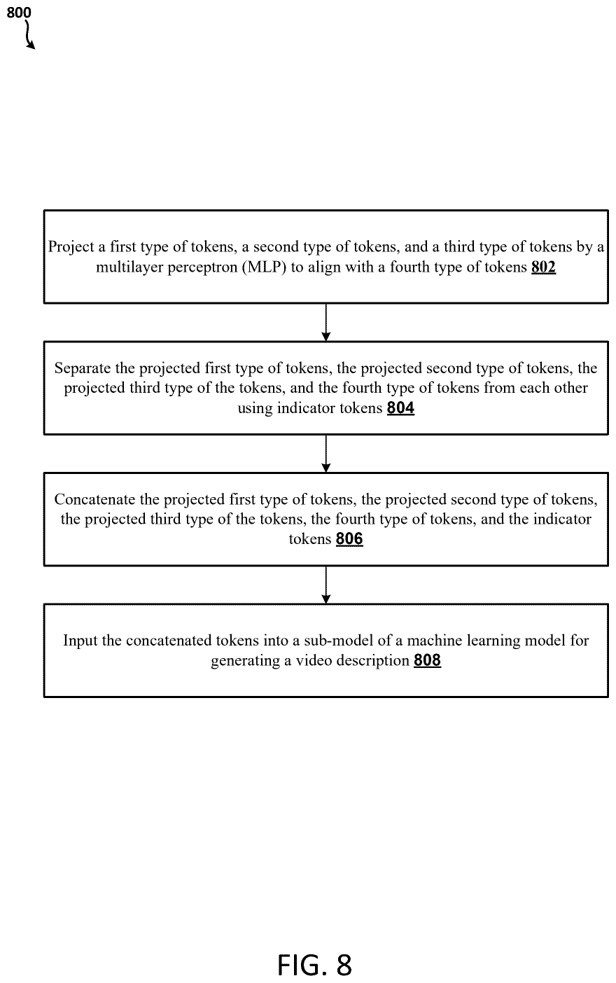

FIG. 8 shows an example process 800 for generating video descriptions using a machine learning model. Although depicted as a sequence of operations in FIG. 8, those of ordinary skill in the art will appreciate that various embodiments may add, remove, reorder, or modify the depicted operations.

A first type of tokens (e.g., first type of tokens 240), a second type of tokens (e.g., second type of tokens 242), and a third type of tokens (e.g., third type of tokens 244) can be input into an MLP (e.g., MLP 302). At 802 the first type of tokens can be projected by the MLP. The first type of tokens can be projected by the MLP to align with a fourth type of tokens (e.g., fourth type of tokens 330). The second type of tokens can be projected by the MLP. The second type of tokens can be projected by the MLP to align with the fourth type of tokens. The third type of tokens can be projected by the MLP. The third type of tokens can be projected by the MLP to align with the fourth type of tokens. For example, the MLP can project the first type of tokens, the second type of tokens, and the third type of tokens into a lower-dimensional space to align with the fourth type of tokens. The fourth type of tokens can include text tokens generated based on an input text query (e.g., text query 130).

At 804, the projected first type of tokens, the projected second type of tokens, the projected third type of the tokens, and the fourth type of tokens can be separated from each other. The projected first type of tokens, the projected second type of tokens, the projected third type of the tokens, and the fourth type of tokens can be separated from each other using indicator tokens. The indicator tokens can enable a sub-model (e.g., sub-model 304) to distinguish between the projected first type of tokens, the projected second type of tokens, the projected third type of the tokens, and the fourth type of tokens. For example, the projected first type of tokens can be separated from the projected second type of tokens using a first indicator token (e.g., indicator token 341). The projected second type of tokens can be separated from the projected third type of the tokens using a second indicator token (e.g., indicator token 343). The projected third type of the tokens can be separated from the fourth type of tokens using a third indicator token (indicator token 345).

At 806, the projected first type of tokens, the projected second type of tokens, the projected third type of the tokens, the fourth type of tokens, and the indicator tokens can be concatenated. At 808, the concatenated tokens can be input into the sub-model. The sub-model can generate a text description (e.g., text output 140) based on the concatenated tokens. The text description can include a description of the video. For example, the text description can be responsive to input text query.

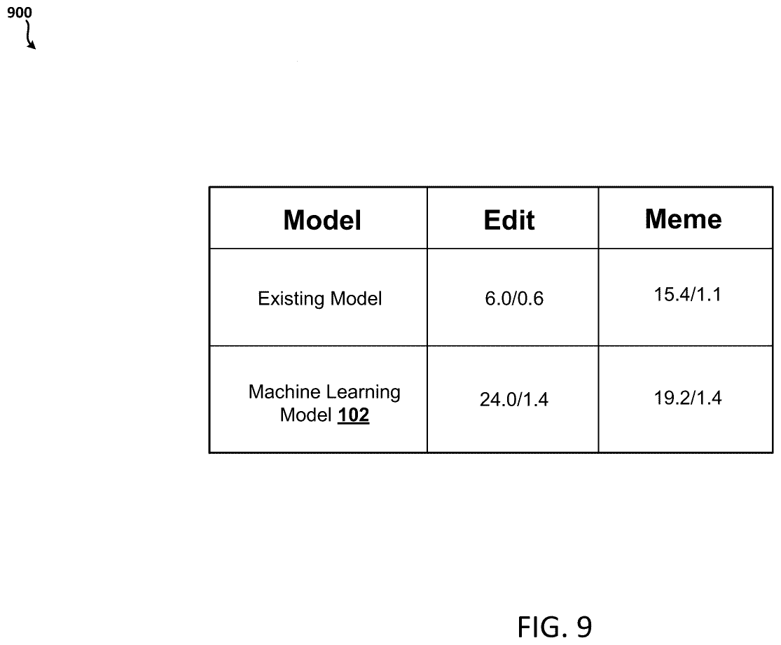

Experiments were conducted to evaluate the performance of the machine learning model 102. The performance of the machine learning model 102 and the performance of an existing model were evaluated on two different kinds of videos: edit videos (e.g., video effects), and meme videos (e.g., short funny videos). The results of the evaluation are shown in the table 900 of FIG. 9. As shown in the table 900, the VQA results generated by the machine learning model 102, which utilizes the three-branch architecture described herein, are better (e.g., associated with a higher score) than the VQA results generated by the existing model on both the edit videos and the meme videos.

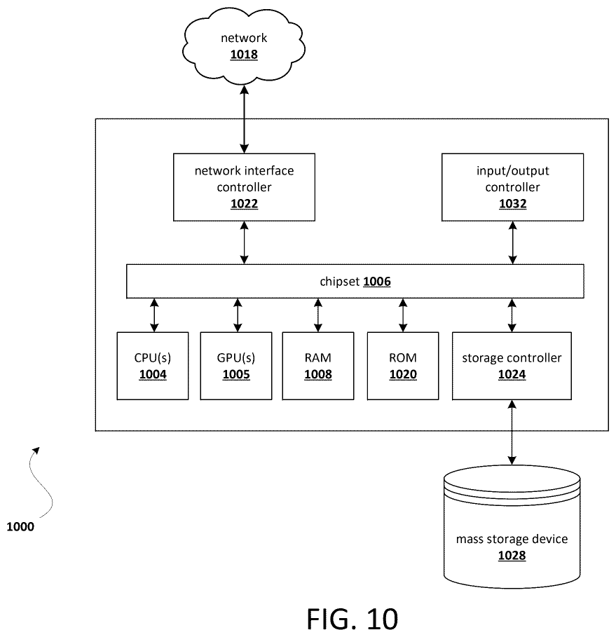

FIG. 10 illustrates a computing device that may be used in various aspects, such as the services, networks, modules, and/or devices depicted in any of FIGS. 1-4. With regard to FIGS. 1-4, any or all of the components may each be implemented by one or more instance of a computing device 1000 of FIG. 10. The computer architecture shown in FIG. 10 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1000 may include a baseboard, or “motherboard,” which is a printed circuit board to which a multitude of components or devices may be connected by way of a system bus or other electrical communication paths. One or more central processing units (CPUs) 1004 may operate in conjunction with a chipset 1006. The CPU(s) 1004 may be standard programmable processors that perform arithmetic and logical operations necessary for the operation of the computing device 1000.

The CPU(s) 1004 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1004 may be augmented with or replaced by other processing units, such as GPU(s) 1005. The GPU(s) 1005 may comprise processing units specialized for but not necessarily limited to highly parallel computations, such as graphics and other visualization-related processing.

A chipset 1006 may provide an interface between the CPU(s) 1004 and the remainder of the components and devices on the baseboard. The chipset 1006 may provide an interface to a random-access memory (RAM) 1008 used as the main memory in the computing device 1000. The chipset 1006 may further provide an interface to a computer-readable storage medium, such as a read-only memory (ROM) 1020 or non-volatile RAM (NVRAM) (not shown), for storing basic routines that may help to start up the computing device 1000 and to transfer information between the various components and devices. ROM 1020 or NVRAM may also store other software components necessary for the operation of the computing device 1000 in accordance with the aspects described herein.

The computing device 1000 may operate in a networked environment using logical connections to remote computing nodes and computer systems through local area network (LAN). The chipset 1006 may include functionality for providing network connectivity through a network interface controller (NIC) 1022, such as a gigabit Ethernet adapter. A NIC 1022 may be capable of connecting the computing device 1000 to other computing nodes over a network 1016. It should be appreciated that multiple NICs 1022 may be present in the computing device 1000, connecting the computing device to other types of networks and remote computer systems.

The computing device 1000 may be connected to a mass storage device 1028 that provides non-volatile storage for the computer. The mass storage device 1028 may store system programs, application programs, other program modules, and data, which have been described in greater detail herein. The mass storage device 1028 may be connected to the computing device 1000 through a storage controller 1024 connected to the chipset 1006. The mass storage device 1028 may consist of one or more physical storage units. The mass storage device 1028 may comprise a management component. A storage controller 1024 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1000 may store data on the mass storage device 1028 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1028 is characterized as primary or secondary storage and the like.

For example, the computing device 1000 may store information to the mass storage device 1028 by issuing instructions through a storage controller 1024 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1000 may further read information from the mass storage device 1028 by detecting the physical states or characteristics of one or more particular locations within the physical storage units.

In addition to the mass storage device 1028 described above, the computing device 1000 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1000.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1028 depicted in FIG. 10, may store an operating system utilized to control the operation of the computing device 1000. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1028 may store other system or application programs and data utilized by the computing device 1000.

The mass storage device 1028 or other computer-readable storage media may also be encoded with computer-executable instructions, which, when loaded into the computing device 1000, transforms the computing device from a general-purpose computing system into a special-purpose computer capable of implementing the aspects described herein. These computer-executable instructions transform the computing device 1000 by specifying how the CPU(s) 1004 transition between states, as described above. The computing device 1000 may have access to computer-readable storage media storing computer-executable instructions, which, when executed by the computing device 1000, may perform the methods described herein.

A computing device, such as the computing device 1000 depicted in FIG. 10, may also include an input/output controller 1032 for receiving and processing input from a number of input devices, such as a keyboard, a mouse, a touchpad, a touch screen, an electronic stylus, or other type of input device. Similarly, an input/output controller 1032 may provide output to a display, such as a computer monitor, a flat-panel display, a digital projector, a printer, a plotter, or other type of output device. It will be appreciated that the computing device 1000 may not include all of the components shown in FIG. 10, may include other components that are not explicitly shown in FIG. 10, or may utilize an architecture completely different than that shown in FIG. 10.

As described herein, a computing device may be a physical computing device, such as the computing device 1000 of FIG. 10. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of generating video descriptions using a machine learning model, comprising:
generating a plurality of sets of visual tokens corresponding to a plurality of frames of a video;
generating a first type of tokens by implementing temporal pooling on the plurality of sets of visual tokens corresponding to the plurality of frames;
generating a second type of tokens by compressing each of the plurality of sets of visual tokens corresponding to each of the plurality of frames;
generating a third type of tokens by applying cross-attention between each of the plurality of sets of visual tokens and a fourth type of tokens, wherein the fourth type of tokens comprise text tokens generated based on an input text query; and
generating a text description of the video based on the first type of tokens, the second type of tokens, the third type of tokens, and the fourth type of tokens.

2. The method of claim 1, wherein the generating a first type of tokens by implementing temporal pooling on the plurality of sets of visual tokens comprises:
generating the first type of tokens based on averaging the plurality of sets of visual tokens across the plurality of frames.

3. The method of claim 1, wherein the generating a second type of tokens by compressing each of the plurality of sets of visual tokens comprises:
generating the second type of tokens based on averaging each of the plurality of sets of visual tokens corresponding to each of the plurality of frames.

4. The method of claim 1, further comprising:
projecting the first type of tokens, the second type of tokens, and the third type of tokens by a multilayer perceptron (MLP) to align with the fourth type of tokens.

5. The method of claim 4, further comprising:
separating the projected first type of tokens, the projected second type of tokens, the projected third type of the tokens, and the fourth type of tokens from each other using indicator tokens.

6. The method of claim 5, further comprising:
concatenating the projected first type of tokens, the projected second type of tokens, the projected third type of the tokens, the fourth type of tokens, and the indicator tokens; and
inputting the concatenated tokens into a sub-model of the machine learning model.

7. The method of claim 6, further comprising:
generating the text description of the video by the sub-model based on the concatenated tokens.

8. The method of claim 1, further comprising:
generating the plurality of sets of visual tokens corresponding to the plurality of frames by a Contrastive Language-Image Pre-Training (CLIP) encoder.

9. A system of generating video descriptions using a machine learning model, comprising:
at least one processor; and
at least one memory communicatively coupled to the at least one processor and comprising computer-readable instructions that upon execution by the at least one processor cause the at least one processor to perform operations comprising:
generating a plurality of sets of visual tokens corresponding to a plurality of frames of a video;
generating a first type of tokens by implementing temporal pooling on the plurality of sets of visual tokens corresponding to the plurality of frames;
generating a second type of tokens by compressing each of the plurality of sets of visual tokens corresponding to each of the plurality of frames;
generating a third type of tokens by applying cross-attention between each of the plurality of sets of visual tokens and a fourth type of tokens, wherein the fourth type of tokens comprise text tokens generated based on an input text query; and
generating a text description of the video based on the first type of tokens, the second type of tokens, the third type of tokens, and the fourth type of tokens.

10. The system of claim 9, wherein the generating a first type of tokens by implementing temporal pooling on the plurality of sets of visual tokens comprises:
generating the first type of tokens based on averaging the plurality of sets of visual tokens across the plurality of frames.

11. The system of claim 9, wherein the generating a second type of tokens by compressing each of the plurality of sets of visual tokens comprises:
generating the second type of tokens based on averaging each of the plurality of sets of visual tokens corresponding to each of the plurality of frames.

12. The system of claim 9, the operations further comprising:
projecting the first type of tokens, the second type of tokens, and the third type of tokens by a multilayer perceptron (MLP) to align with the fourth type of tokens.

13. The system of claim 12, the operations further comprising:
separating the projected first type of tokens, the projected second type of tokens, the projected third type of the tokens, and the fourth type of tokens from each other using indicator tokens;
concatenating the projected first type of tokens, the projected second type of tokens, the projected third type of the tokens, the fourth type of tokens, and the indicator tokens; and
inputting the concatenated tokens into a sub-model of the machine learning model.

14. The system of claim 13, the operations further comprising:
generating the text description of the video by the sub-model based on the concatenated tokens.

15. A non-transitory computer-readable storage medium, storing computer-readable instructions that upon execution by a processor cause the processor to implement operations comprising:
generating a plurality of sets of visual tokens corresponding to a plurality of frames of a video;
generating a first type of tokens by implementing temporal pooling on the plurality of sets of visual tokens corresponding to the plurality of frames;
generating a second type of tokens by compressing each of the plurality of sets of visual tokens corresponding to each of the plurality of frames;
generating a third type of tokens by applying cross-attention between each of the plurality of sets of visual tokens and a fourth type of tokens, wherein the fourth type of tokens comprise text tokens generated based on an input text query; and
generating a text description of the video based on the first type of tokens, the second type of tokens, the third type of tokens, and the fourth type of tokens.

16. The non-transitory computer-readable storage medium of claim 15, wherein the generating a first type of tokens by implementing temporal pooling on the plurality of sets of visual tokens comprises:
generating the first type of tokens based on averaging the plurality of sets of visual tokens across the plurality of frames.

17. The non-transitory computer-readable storage medium of claim 15, wherein the generating a second type of tokens by compressing each of the plurality of sets of visual tokens comprises:
generating the second type of tokens based on averaging each of the plurality of sets of visual tokens corresponding to each of the plurality of frames.

18. The non-transitory computer-readable storage medium of claim 15, the operations further comprising:
projecting the first type of tokens, the second type of tokens, and the third type of tokens by a multilayer perceptron (MLP) to align with the fourth type of tokens.

19. The non-transitory computer-readable storage medium of claim 18, the operations further comprising:
separating the projected first type of tokens, the projected second type of tokens, the projected third type of the tokens, and the fourth type of tokens from each other using indicator tokens;
concatenating the projected first type of tokens, the projected second type of tokens, the projected third type of the tokens, the fourth type of tokens, and the indicator tokens; and
inputting the concatenated tokens into a sub-model of the machine learning model.

20. The non-transitory computer-readable storage medium of claim 19, the operations further comprising:
generating the text description of the video by the sub-model based on the concatenated tokens.
